(19) United States
(12) Patent Application Publication
(10) Pub. No.: US 2021/0026426 A1
(43) Pub. Date: Jan. 28, 2021

(54) SINGLE PORT POWER AND DATA TRANSMITTING

(71) Applicant: International Business Machines Corporation, Armonk, NY (US)

(72) Inventors: Rogelio Fernando Gutierrez Valdes, Tlaquepaque (MX); Ana Maria Najar Petersen, Zapopan (MX); Marco Gerardo Vazquez Martin, Tepatitlán (MX); Andres Duran Rocha, Guadalajara (MX)

(21) Appl. No.: 16/517,812

(22) Filed: Jul. 22, 2019

(51) Int. Cl. G06F 1/26; G06F 13/42

(52) U.S. Cl. CPC G06F 1/26; G06F 2213/0042; G06F 13/4282

(57) ABSTRACT

Aspects of the present disclosure provide a computer-implemented method that includes receiving, at a power-data device, a power-data signal including a data signal modulated with a power signal. The method further includes transforming, by a power transformer of the power-data device, the power signal of the power-data signal from a first voltage to a second voltage to generate a transformed power signal. The method further includes demodulating, by a modem of the power-data device, the power-data signal to generate a demodulated data signal. The method further includes transmitting, by the power-data device, the transformed power signal of the power-data signal and the demodulated data signal of the power-data signal to a computing device electrically coupled to the power-data device by a single cable coupled between the power-data device and a single port of the computing device.

### BACKGROUND

The present invention generally relates to computer processing devices, and more specifically, to single port power and data transmitting.

Computer processing devices, such as laptop computing devices, desktop or workstation computing devices, smart/mobile phones, tablet computing devices, and the like use electric power to operate. Electric power can be provided by a battery, by grid power, or by another suitable power source. Such computer processing devices can also communicate with other computer processing devices using various communication techniques.

### SUMMARY

Embodiments of the present invention are directed to single port power and data transmitting.

A non-limiting example computer-implemented method includes receiving, at a power-data device, a power-data signal including a data signal modulated with a power signal. The method further includes transforming, by a power transformer of the power-data device, the power signal of the power-data signal from a first voltage to a second voltage to generate a transformed power signal. The method further includes demodulating, by a modem of the power-data device, the power-data signal to generate a demodulated data signal. The method further includes transmitting, by the power-data device, the transformed power signal of the power-data signal and the demodulated data signal of the power-data signal to a computing device electrically coupled to the power-data device by a single cable coupled between the power-data device and a single port of the computing device.

A non-limiting example system includes a power source to generate a power signal. The system further includes a data source to generate a data signal. The data signal is transmitted with the power signal as a power-data signal. The system further includes a computing device having at least one port. The system further includes a power-data device electrically coupled to the computing device by a single cable coupling to a single port of the computing device. The power-data device is configured to receive the power-data signal. The power-data device is further configured to transform, by a power transformer of the power-data device, a power signal of the power-data signal from a first voltage to a second voltage. The power-data device is further configured to demodulate, by a modem of the power-data device, a data signal from the power-data signal. The power-data device is further configured to transmit the transformed power signal of the power-data signal and the demodulated data signal of the power-data signal to the computing device.

A non-limiting example power-data device is electrically coupled to a computing device by a single cable coupling to a single port of the computing device. The power-data device is configured to receive a power-data signal. The power-data device is further configured to transform, by a power transformer of the power-data device, a power signal of the power-data signal from a first voltage to a second voltage. The power-data device is further configured to demodulate, by a modem of the power-data device, a data signal from the power-data signal. The power-data device is further configured to transmit the transformed power signal of the power-data signal and the demodulated data signal of the power-data signal to the computing device via the single cable.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a power-data device for single port power and data transmitting according to one or more embodiments described herein;

FIG. 2 depicts a block diagram of the power-data device of FIG. 1 for single port power and data transmitting according to one or more embodiments described herein;

FIG. 3 depicts a flow diagram of a method for single port power and data transmitting according to one or more embodiments described herein; and

FIG. 4 depicts a block diagram of a processing system for implementing the presently described techniques according to one or more embodiments described herein.

The diagrams depicted herein are illustrative. There can be many variations to the diagram or the operations described therein without departing from the scope of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provide single port power and data transmitting. In particular, a power-data device is provided that enables a computing device to receive power and data via a single cable connected to a single port of the computing device.

Computing devices use electric power (referred to herein simply as “power”) to operate. In some cases, a computing device includes a battery that can provide power to the computing device, while in other cases, the computing device includes (or is connected to) a power supply that in turn is connected to a power source. The power source provides power to the power supply, which, in turns, powers the computing device and/or recharges a battery associated with the computing device.

Computing devices also frequently send data to and receive data from other computing devices. For example, a computing device may connect to a network such as the Internet to provide communication, information search, file transfer, multimedia streaming, and other functionality. Often times, a particular area, structure, building, etc., includes infrastructure to enable computing devices to communicate with one another and/or with networks such as the Internet. Such infrastructure can include wired and/or wireless networking components. However, sometimes wired and/or wireless networking is not available, feasible, and/or cost effective for a particular environment. For example, in an older residential house, wired (data) infrastructure may not be available, and wireless infrastructure may not work well (e.g., too great a distance, too much interference, etc.). In such cases, electric power infrastructure can be used for data transmission. Examples of this include power line communication (PLC), broadband power local area network (BPL), and the like. However, one disadvantage of these approaches is that a physical powerline modulation-demodulation device (“powerline modem”) is needed. Traditionally, a network cable is connected between a networking (e.g., Ethernet) port of the computing device and the powerline modem. Separately, the computing device receives power from a power supply or power source via a separate cable. However, due to the reduction and simplification of ports in modern computing devices (especially laptops and tablets), such computing devices may no longer include a dedicated network port.

One or more embodiments of the present invention address the shortcomings of the prior art by providing a power-data device that enables a computing device to receive power and data via a single cable connected to a single port of the computing device. An advantage of the power-data device described herein is that it enables a computing device that may lack a dedicated network adapter to be connected to a network. Thus, one or more embodiments of the present invention can provide the advantages associated with PLC/BPL without requiring a dedicated network port on the computing device. Another advantage of one or more embodiments of the power-data device described herein is that it enables electric power infrastructure to be used instead of dedicated networking cabling and/or wireless infrastructure, thereby reducing costs, network complexity, power usage, and the like. Yet another advantage of one or more embodiments of the power-data device described herein is that it uses only a single port of the computing device that would already be used for receiving electric power, thus freeing up other ports (if so equipped). An additional advantage of one or more embodiments of the power-data device described herein is that its functionality can be implemented in a traditional charging device (e.g., a laptop charger), thus replacing two devices (a laptop charger and a powerline modem) with a single device (i.e., the power-data device).

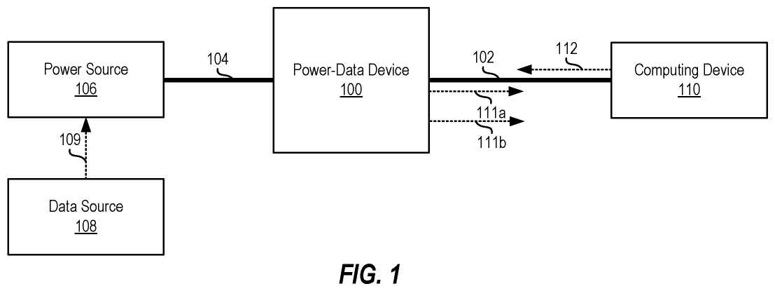

FIG. 1 depicts a block diagram of a power-data device 100 for single port power and data transmitting according to one or more embodiments described herein. The power-data device 100 enables a computing device 110 to receive power and data via a single cable 102 so that the computing device 110 need only use a single port on the computing device 110 to receive both power and data. The single cable 102 can transmit a demodulated data signal (e.g., the signal 111a) of the power-data signal and a transformed power signal (e.g., the signal 111b) of the power-data signal to the computing device 110. The single cable 102 can also be used to transmit a data signal (i.e., the data signal 112) from the computing device 110 to the power-data device 100.

The power-data device 100 receives a power-data signal over an electrical cable 104 connected between the power-data device 100 and a power source 106. The power-data signal includes a data signal modulated with a power signal. The power source 106 provides the power signal, and a data source 108 modulates the data signal to the power source, as shown by the arrow 109. In this way, the power-data device 100 receives a single power-data signal via the electrical cable 104. Examples of types of power-data signals include PLC signals, BPL signals, and the like.

In examples, the data source 108 can include or be connected to a network or networks (not shown). The network(s) represents any one or a combination of different types of suitable communications networks such as, for example, cable networks, public networks (e.g., the Internet), private networks, wireless networks, cellular networks, or any other suitable private and/or public networks. Further, the network(s) may have any suitable communication range associated therewith and may include, for example, global networks (e.g., the Internet), metropolitan area networks (MANs), wide area networks (WANs), local area networks (LANs), or personal area networks (PANs). In addition, the network(s) can include any type of medium over which network traffic may be carried including, but not limited to, power cable, coaxial cable, twisted-pair wire, optical fiber, a hybrid fiber coaxial (HFC) medium, microwave terrestrial transceivers, radio frequency communication mediums, satellite communication mediums, or any combination thereof.

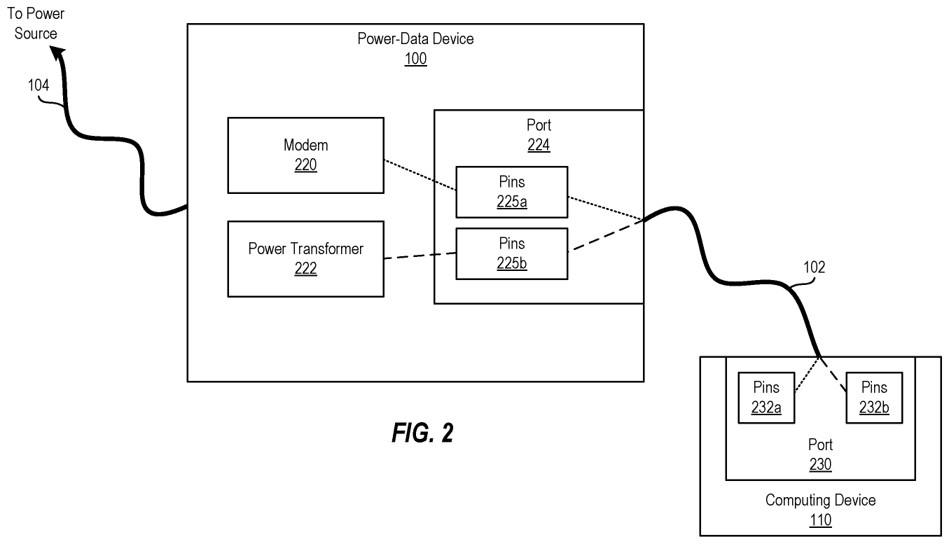

FIG. 2 depicts a block diagram of the power-data device 100 of FIG. 1 for single port power and data transmitting according to one or more embodiments described herein. In this example, the power-data device 100 includes a modem 220, a power transformer 222, and a port 224 that includes a plurality of pins 225a, 225b.

The modem 220 performs modulation and demodulation functions. For example, when the power-data device 100 receives a power-data signal, the modem 220 demodulates the power-data signal to generate a data signal that can be transmitted to the computing device 110. Similarly, when the power-data device 100 receives a data signal (i.e., the data signal 112) from the computing device 110, the modem 220 modulates the data signal that can be transmitted to another computing device using another power-data signal, for example.

The power transformer 222 performs transformations on a power signal component of the power-data signal. The power transformer 222 can “step down” voltage from a higher voltage to a lower voltage and/or can “step up” voltage from a lower voltage to a higher voltage. For example, the power transformer 222 can transform a voltage in the range of 100-220 volts to a voltage in the range of 5-10 volts, for example. Of course, these voltage ranges are merely examples and other voltage ranges are possible. The power transformer 222 can also transform power from alternating current (AC) to direct current (DC) and/or from DC to AC.

The port 224 (also referred to as a “power-data port”) of the power-data device 100 can receive one end of the single cable 102. In some examples, the port 224 is a universal serial bus type-C (USB-C) port and thus is configured to receive a USB-C adapter of the single cable 102 (i.e., the single cable 102 is a USB-C cable). It should be appreciated that the port 224 can be another type of port other than USB-C and thus can be configured to receive another type of adapter. As shown in FIG. 2, the port 224 of the power-data device 100 includes pins 232a, 232b. The pins 232b are enabled to transmit the transformed power signal to the computing device 110, and the pins 232a are enabled to transmit the demodulated data signal to the computing device 110.

The dotted lines 240a in FIG. 2 show data pathways among the modem 220, the pins 225a, and the pins 232b. The dashed lines 240b in FIG. 2 show power pathways among the power transformer 222, the pins 225b, and the pins 232b. As can be seen in FIG. 2, the dotted lines 240a (data pathways) and dashed lines 240b (power pathways) are combined in the single cable 102, thus enabling the power-data device 100 to transmit both power and data from the power-data device 100 to the computing device 110 using the single cable 102 and a single port (i.e., the port 230) of the computing device 110.

The single port (i.e., the port 230) of the computing device 110 can be a USB-C port or another suitable port. Accordingly, the port is configured to receive a particular type of adapter (e.g., a USB-C adapter) of the single cable 102. In examples, the port 230 of the computing device 110 includes pins 232a, 232b. The pins 232b are enabled to receive the transformed power signal from the power-data device 100 via the single cable and the pins 232a are enabled to receive the demodulated data signal from the power-data device 100 via the single cable 102.

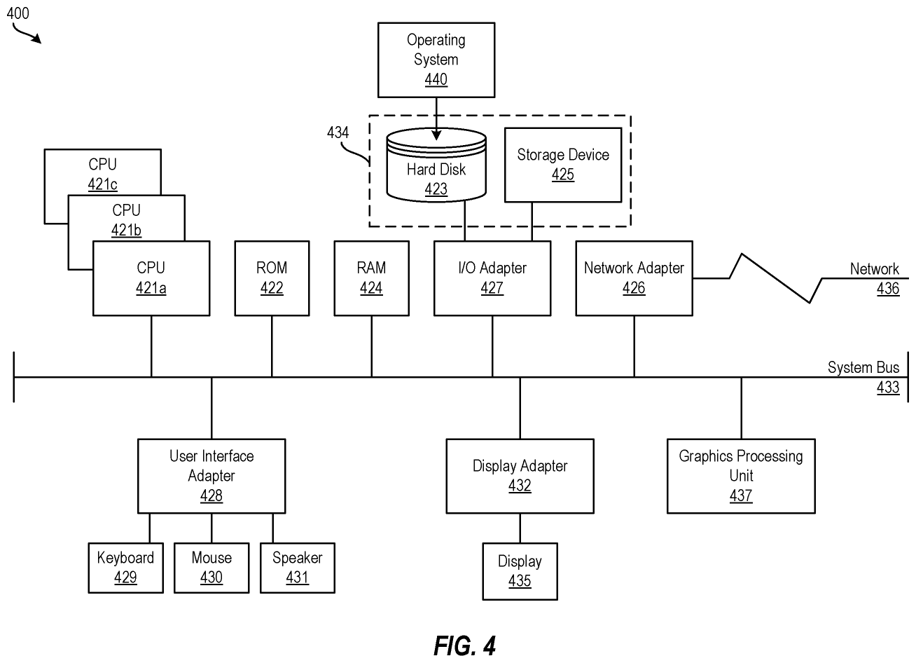

The computing device 110 can also include a memory and a processing device (shown in FIG. 4 as processors 421 and RAM 424). The memory stores computer readable instructions, which are executable by the processing resource to control the processing device to perform various operations. In one example, the computer readable instructions include a driver to communicate with an operating system executing on the computing device 110. The driver enables the operating system to transmit and receive data via the power-data device 100 through the port 230.

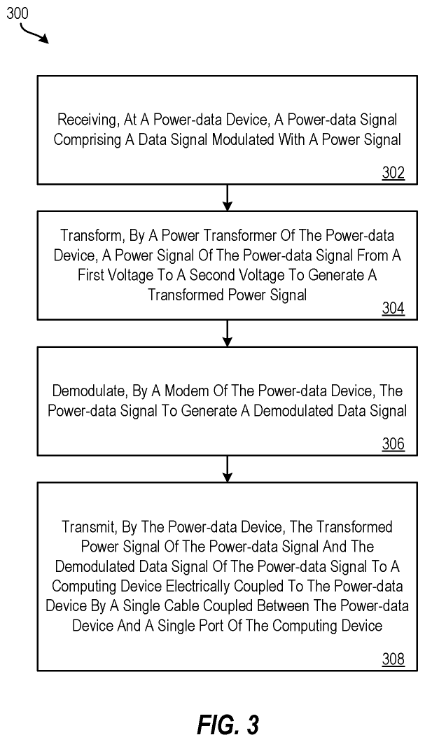

FIG. 3 depicts a flow diagram of a method 300 for single port power and data transmitting according to one or more embodiments described herein. The method 300 can be implemented, for example, by the power-data device 100 of FIGS. 1 and 2, or by another suitable device.

At block 302, the power-data device 100 receives a power-data signal from the power source 106. The power-data signal includes a data signal modulated with a power signal. The power-data signal can be a PLC signal, a BPL signal, or another suitable signal that carries both power and data together.

At block 304, the power transformer 222 of the power-data device 100 transforms a power signal of the power-data signal from a first voltage to a second voltage to generate a transformed power signal. Thus, the transform 222 provides voltage transformation functionality, as described herein, to the power-data device 100.

At block 306, the modem 220 of the power-data device 100 demodulates the power-data signal to generate a demodulated data signal. Thus the modem 220 acts as a demodulator and is enabled to extract information from a carrier wave (i.e., from the power data signal). The modem 220 can generate a data signal containing the extracted information.

At block 308, the power-data device 100 transmits the transformed power signal (e.g., the signal 111b of FIG. 1) of the power-data signal and the demodulated data signal (e.g., the signal 111a of FIG. 1) of the power-data signal to the computing device 110. The computing device 110 is electrically coupled to the power-data device 100 by a single cable 102 coupled between the power-data device 100 and a single port (i.e., the port 230) of the computing device 110.

Additional processes also may be included. For example, the power-data device 100 can also receive a data signal (e.g., the data signal 112) from the computing device 110. The modem 220 of the power-data device 100 modulates the data signal (e.g., the data signal 112). Thus the modem 220 acts as a modulator and is able to inject information into carrier wave (i.e., the data signal). The power-data device 100 transmits the modulated data signal to another computing device using a second power-data signal. Accordingly, the power-data device 100 enables by bidirectional communication between the computing device 110 and other computing devices. It should be understood that the process depicted in FIG. 3 represents an illustration, and that other processes may be added or existing processes may be removed, modified, or rearranged without departing from the scope of the present disclosure.

It is understood that one or more embodiments described herein are capable of being implemented in conjunction with any other type of computing environment now known or later developed. For example, FIG. 4 depicts a block diagram of a processing system 400 for implementing the techniques described herein. In accordance with one or more embodiments of the present invention, the processing system 400 is an example of the computing device 110 of FIGS. 1 and 2. In examples, processing system 400 has one or more central processing units (“processors” or “processing resources”) 421a, 421b, 421c, etc. (collectively or generically referred to as processor(s) 421 and/or as processing device(s)). In aspects of the present disclosure, each processor 421 can include a reduced instruction set computer (RISC) microprocessor. Processors 421 are coupled to system memory (e.g., random access memory (RAM) 424) and various other components via a system bus 433. Read only memory (ROM) 422 is coupled to system bus 433 and may include a basic input/output system (BIOS), which controls certain basic functions of processing system 400.

Further depicted are an input/output (I/O) adapter 427 and a network adapter 426 coupled to system bus 433. I/O adapter 427 may be a small computer system interface (SCSI) adapter that communicates with a hard disk 423 and/or a storage device 425 or any other similar component. I/O adapter 427, hard disk 423, and storage device 425 are collectively referred to herein as mass storage 434. Operating system 440 for execution on processing system 400 may be stored in mass storage 434. The network adapter 426 interconnects system bus 433 with an outside network 436 enabling the processing system 400 to communicate with other such systems.

A display (e.g., a display monitor) 435 is connected to system bus 433 by display adapter 432, which may include a graphics adapter to improve the performance of graphics intensive applications and a video controller. In one aspect of the present disclosure, adapters 426, 427, and/or 432 may be connected to one or more I/O busses that are connected to system bus 433 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 433 via user interface adapter 428 and display adapter 432. A keyboard 429, mouse 430, and speaker 431 may be interconnected to system bus 433 via user interface adapter 428, which may include, for example, a Super I/O chip integrating multiple device adapters into a single integrated circuit.

In some aspects of the present disclosure, processing system 400 includes a graphics processing unit 437. Graphics processing unit 437 is a specialized electronic circuit designed to manipulate and alter memory to accelerate the creation of images in a frame buffer intended for output to a display. In general, graphics processing unit 437 is very efficient at manipulating computer graphics and image processing, and has a highly parallel structure that makes it more effective than general-purpose CPUs for algorithms where processing of large blocks of data is done in parallel.

Thus, as configured herein, processing system 400 includes processing capability in the form of processors 421, storage capability including system memory (e.g., RAM 424), and mass storage 434, input means such as keyboard 429 and mouse 430, and output capability including speaker 431 and display 435. In some aspects of the present disclosure, a portion of system memory (e.g., RAM 424) and mass storage 434 collectively store the operating system 440 such as the AIX® operating system from IBM Corporation to coordinate the functions of the various components shown in processing system 400.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, at a power-data device, a power-data signal comprising a data signal modulated with a power signal;
transforming, by a power transformer of the power-data device, the power signal of the power-data signal from a first voltage to a second voltage to generate a transformed power signal;
demodulating, by a modem of the power-data device, the power-data signal to generate a demodulated data signal; and
transmitting, by the power-data device, the transformed power signal of the power-data signal and the demodulated data signal of the power-data signal to a computing device electrically coupled to the power-data device by a single cable coupled between the power-data device and a single port of the computing device.

2. The computer-implemented method of claim 1, wherein the single port of the computing device is a universal serial bus type-C (USB-C) port.

3. The computer-implemented method of claim 2, wherein the USB-C port of the computing device comprises a plurality of pins, a first subset of the plurality of pins being enabled to receive the transformed power signal from the power-data device via the single cable, and a second subset of the plurality of pins enabled to receive the demodulated data signal from the power-data device via the single cable.

4. The computer-implemented method of claim 1, wherein the power-data device comprises a power-data port to receive one end of the single cable.

5. The computer-implemented method of claim 4, wherein the power-data port is a universal serial bus type-C (USB-C) port.

6. The computer-implemented method of claim 5, wherein the USB-C port of the power-data device comprises a plurality of pins, a first subset of the plurality of pins being enabled to transmit the transformed power signal to the computing device, and a second subset of the plurality of pins enabled to transmit the demodulated data signal to the computing device.

7. The computer-implemented method of claim 1, wherein the first voltage is in a range of 100 to 220 volts of alternating current, and wherein the second voltage is in a range of 5 to 10 volts of direct current.

8. The computer-implemented method of claim 1, wherein the power-data signal is a power line communication (PLC) signal.

9. The computer-implemented method of claim 1, wherein the power-data signal is a broadband power local area network (BPL) signal.

10. The computer-implemented method of claim 1, further comprising:
receiving, at the power-data device, a second data signal from the computing device;
modulating, by the modem of the power-data device, the second data signal; and
transmitting, by the power-data device, the modulated data signal to another computing device using a second power-data signal.

11. A system comprising:
a power source to generate a power signal;
a data source to generate a data signal, wherein the data signal is transmitted with the power signal as a power-data signal;
a computing device comprising at least one port;
a power-data device electrically coupled to the computing device by a single cable coupling to a single port of the computing device, the power-data device configured to:
receive the power-data signal;
transform, by a power transformer of the power-data device, a power signal of the power-data signal from a first voltage to a second voltage;
demodulate, by a modem of the power-data device, a data signal from the power-data signal; and
transmit the transformed power signal of the power-data signal and the demodulated data signal of the power-data signal to the computing device.

12. The system of claim 11, wherein the single port of the computing device is a universal serial bus type-C (USB-C) port.

13. The system of claim 12, wherein the USB-C port of the computing device comprises a plurality of pins, a first subset of the plurality of pins being enabled to receive the transformed power signal from the power-data device via the single cable, and a second subset of the plurality of pins enabled to receive the demodulated data signal from the power-data device via the single cable.

14. The system of claim 11, wherein the power-data device comprises a power-data port to receive one end of the single cable.

15. The system of claim 14, wherein the power-data port is a universal serial bus type-C (USB-C) port.

16. The system of claim 15, wherein the USB-C port of the power-data device comprises a plurality of pins, a first subset of the plurality of pins being enabled to transmit the transformed power signal to the computing device, and a second subset of the plurality of pins enabled to transmit the demodulated data signal to the computing device.

17. The system of claim 11, wherein the first voltage is in a range of 100 to 220 volts of alternating current, and wherein the second voltage is in a range of 5 to 10 volts of direct current.

18. The system of claim 11, wherein the power-data signal is a power line communication (PLC) signal.

19. The system of claim 11, wherein the power-data signal is a broadband power local area network (BPL) signal.

20. A power-data device electrically coupled to a computing device by a single cable coupling to a single port of the computing device, the power-data device configured to:
receive a power-data signal;
transform, by a power transformer of the power-data device, a power signal of the power-data signal from a first voltage to a second voltage;
demodulate, by a modem of the power-data device, a data signal from the power-data signal; and
transmit the transformed power signal of the power-data signal and the demodulated data signal of the power-data signal to the computing device via the single cable.
